(19) United States
(12) Patent Application Publication
(10) Pub. No.: US 2025/0069326 A1
(43) Pub. Date: Feb. 27, 2025

(54) METHOD AND APPARATUS FOR RENDERING IMAGE, AND ELECTRONIC DEVICE

(71) Applicant: BOE Technology Group Co., Ltd., Beijing (CN)

(72) Inventors: Zhe ZHANG, Beijing (CN); Naichuan CHEN, Beijing (CN); Danfeng ZHU, Beijing (CN); Hongxiang SHEN, Beijing (CN)

(21) Appl. No.: 18/576,357

(22) PCT Filed: Dec. 23, 2022
(86) PCT No.: PCT/CN2022/141612

§ 371 Date: Jan. 3, 2024

(51) Int. Cl. G06T 17/00; G06T 5/20; G06T 7/12; G06T 7/13

(52) U.S. Cl. CPC G06T 17/00; G06T 5/20; G06T 7/12; G06T 7/13; G06T 2200/04; G06T 2210/56

(57) ABSTRACT

Provided is a method for rendering an image. The method includes: acquiring a plurality of pieces of raw point cloud data by scanning an object with a scanning device, wherein any one piece of raw point cloud data is configured to describe a data acquisition point on the object; determining at least one piece of boundary line data based on the plurality of pieces of raw point cloud data, wherein any one piece of boundary line data is configured to describe a contour boundary on the object; and determining an object image based on the plurality of pieces of raw point cloud data and the at least one piece of boundary line data, and rendering the object image.

### CROSS-REFERENCE TO RELATED APPLICATION

This application is a U.S. national phase application based on PCT/CN2022/141612, filed on Dec. 23, 2022, the content of which is incorporated herein by reference in its entirety.

### TECHNICAL FIELD

The present disclosure relates to the field of computer technologies, in particular, relate to a method and an apparatus for rendering an image, and an electronic device.

### BACKGROUND

With the continuous development of computer technology, extended reality technology is also evolving. Extended reality technology includes various techniques such as augmented reality, virtual reality, mixed reality, and the like. These techniques can integrate virtual scenes with real scenes, providing an immersive experience for users. In extended reality, image rendering technology is crucial, and how to determine object images and render the object images becomes a key technology.

### SUMMARY

The present disclosure provides a method and an apparatus for rendering an image, and an electronic device, to solve the problems in the related art. The technical solutions are as follows.

In one aspect, a method for rendering an image is provided. The method includes:
acquiring a plurality of pieces of raw point cloud data by scanning an object with a scanning device wherein any one piece of raw point cloud data is configured to describe a data acquisition point on the object;
determining at least one piece of boundary line data based on the plurality of pieces of raw point cloud data, wherein any one piece of boundary line data is configured to describe a contour boundary on the object; and
determining an object image based on the plurality of pieces of raw point cloud data and the at least one piece of boundary line data, and rendering the object image.

In some embodiments, determining at least one piece of boundary line data based on the plurality of pieces of raw point cloud data includes:
acquiring a plurality of pieces of target point cloud data by filtering out raw point cloud data satisfying a filtering condition from the plurality of pieces of raw point cloud data; and
determining at least one piece of boundary line data based on the plurality of pieces of target point cloud data; and
determining the object image based on the plurality of pieces of raw point cloud data and the at least one piece of boundary line data includes:
determining the object image based on the plurality of pieces of target point cloud data and the at least one piece of boundary line data.

In some embodiments, the any one piece of raw point cloud data includes coordinate data; and the raw point cloud data satisfying the filtering condition includes raw point cloud data with coordinate data outside of a set area;
and/or, the any one piece of raw point cloud data includes color data; and the raw point cloud data satisfying the filtering condition includes raw point cloud data with color data matching a set color;
and/or, the any one piece of raw point cloud data includes reflection intensity data; and the raw point cloud data satisfying the filtering condition includes raw point cloud data with reflection intensity data less than a set reflection intensity.

In some embodiments, determining at least one piece of boundary line data based on the plurality of pieces of target point cloud data includes:
acquiring at least two first point cloud clusters by partitioning the plurality of pieces of target point cloud data, wherein any first point cloud cluster includes at least one piece of target point cloud data;
determining, for any two first point cloud clusters, boundary line data between the any two first point cloud clusters based on each piece of target point cloud data in the any two first point cloud clusters; and
determining, in a case that the at least two first point cloud clusters satisfy a partitioning condition, boundary line data between every two first point cloud clusters as at least one piece of boundary line data.

In some embodiments, acquiring at least two first point cloud clusters by partitioning the plurality of pieces of target point cloud data includes:
determining, for any two pieces of target point cloud data, a distance between the any two pieces of target point cloud data based on coordinate data in the any two pieces of target point cloud data; and
partitioning, in a case that a difference between color data in the any two pieces of target point cloud data is less than a first threshold and a distance between the any two pieces of target point cloud data is less than a second threshold, the any two pieces of target point cloud data into a same first point cloud cluster.

In some embodiments, determining the piece of boundary line data between the any two first point cloud clusters based on each piece of target point cloud data in the any two first point cloud clusters includes:
determining a plurality of pieces of reference point cloud data from the each piece of target point cloud data in the any two first point cloud clusters, wherein a distance between the reference point cloud data and one of the any two first point cloud clusters is less than a third threshold, and a distance between the reference point cloud data and the other of the any two first point cloud clusters is less than a fourth threshold;
determining, for any two pieces of reference point cloud data, a piece of straight-line data based on the any two pieces of reference point cloud data;
determining distances between other point cloud data and the straight-line data, wherein the other point cloud data are target point cloud data from the each piece of target point cloud data in the any two first point cloud clusters except the any two pieces of reference point cloud data; and
determining, in a case that a quantity of other point cloud data with distances to the straight-line data less than a fifth threshold satisfies a quantity condition, the straight-line data as the piece of boundary line data between the any two first point cloud clusters.

In some embodiments, the method further includes:
acquiring at least two second point cloud clusters by partitioning, for any first point cloud cluster, in a case that the at least two first point cloud clusters do not satisfy the partitioning condition, each piece of target point cloud data in the any first point cloud cluster, wherein any second point cloud cluster includes at least one piece of target point cloud data;
determining, for any two second point cloud clusters, a piece of boundary line data between the any two second point cloud clusters based on each piece of target point cloud data in the any two second point cloud clusters; and
determining, in a case that each second point cloud cluster satisfies the partitioning condition, boundary line data between every two first point cloud clusters and boundary line data between every two second point cloud clusters as at least one piece of boundary line data.

In some embodiments, rendering the object image includes:
acquiring an offset between a reference point of a display screen on a head-mounted display device and a reference point of the object image;
acquiring an offset object image by offsetting the object image based on the offset; and
rendering the offset object image on the display screen.

In another aspect, an apparatus for rendering an image is provided. The apparatus includes:
a scanning module, configured to acquire a plurality of pieces of raw point cloud data by scanning an object with a scanning device, wherein any one piece of raw point cloud data is configured to describe a data acquisition point on the object;
a determining module, configured to determine at least one piece of boundary line data based on the plurality of pieces of raw point cloud data, wherein any one piece of boundary line data is configured to describe a contour boundary on the object, wherein
the determining module is further configured to determine an object image based on the plurality of pieces of raw point cloud data and the at least one piece of boundary line data; and
a rendering module, configured to render the object image.

In some embodiments, the determining module is configured to acquire a plurality of pieces of target point cloud data by filtering out raw point cloud data satisfying a filtering condition from the plurality of pieces of raw point cloud data; determine at least one piece of boundary line data based on the plurality of pieces of target point cloud data; and determine an object image based on the plurality of pieces of target point cloud data and the at least one piece of boundary line data.

In some embodiments, the any one piece of raw point cloud data includes coordinate data; and the raw point cloud data satisfying the filtering condition includes raw point cloud data with coordinate data outside of a set area;
and/or, the any one piece of raw point cloud data includes color data; and the raw point cloud data satisfying the filtering condition includes raw point cloud data with color data matching a set color;
and/or, the any one piece of raw point cloud data includes reflection intensity data; and the raw point cloud data satisfying the filtering condition includes raw point cloud data with reflection intensity data less than a set reflection intensity.

In some embodiments, the determining module is configured to acquire at least two first point cloud clusters by partitioning the plurality of pieces of target point cloud data, wherein any first point cloud cluster includes at least one piece of target point cloud data; determine, for any two first point cloud clusters, boundary line data between the any two first point cloud clusters based on each piece of target point cloud data in the any two first point cloud clusters; and determine, in a case that the at least two first point cloud clusters satisfy a partitioning condition, boundary line data between every two first point cloud clusters as at least one piece of boundary line data.

In some embodiments, the determining module is configured to determine, for any two pieces of target point cloud data, a distance between the any two pieces of target point cloud data based on coordinate data in the any two pieces of target point cloud data; and partition, in a case that a difference between color data in the any two pieces of target point cloud data is less than the first threshold and a distance between the any two pieces of target point cloud data is less than a second threshold, the any two pieces of target point cloud data into a same first point cloud cluster.

In some embodiments, the determining module is configured to determine a plurality of pieces of reference point cloud data from the each piece of target point cloud data in the any two first point cloud clusters, wherein a distance between the reference point cloud data and one of the any two first point cloud clusters is less than a third threshold, and a distance between the reference point cloud data and the other of the any two first point cloud clusters is less than a fourth threshold; determine, for any two pieces of reference point cloud data, a piece of straight-line data based on the any two pieces of reference point cloud data; determine distances between other point cloud data and the straight-line data, wherein the other point cloud data are target point cloud data from the each piece of target point cloud data in the any two first point cloud clusters except the any two pieces of reference point cloud data; and determine, in a case that a quantity of other point cloud data with a distance to the straight-line data less than a fifth threshold satisfies a quantity condition, the straight-line data as the boundary line data between the any two first point cloud clusters.

In some embodiments, the determining module is further configured to acquire at least two second point cloud clusters by partitioning, for any first point cloud cluster, in a case that the at least two first point cloud clusters do not satisfy the partitioning condition, each piece of target point cloud data in the any first point cloud cluster, wherein any second point cloud cluster includes at least one piece of target point cloud data; determine, for any two second point cloud clusters, boundary line data between the any two second point cloud clusters based on each piece of target point cloud data in the any two second point cloud clusters; and determine, in a case that each second point cloud cluster satisfies the partitioning condition, boundary line data between every two first point cloud clusters and boundary line data between every two second point cloud clusters as at least one piece of boundary line data.

In some embodiments, the rendering module is configured to acquire an offset between a reference point of a display screen on a head-mounted display device and a reference point of the object image; acquire an offset object image by offsetting the object image based on the offset; and render the offset object image on the display screen.

In another aspect, an electronic device is provided. The electronic device includes a processor and a memory storing at least one computer program, wherein the at least one computer program, when loaded and executed by the processor, causes the electronic device to perform the method for rendering the image described above.

In another aspect, a computer-readable storage medium is further provided. The computer-readable storage medium stores at least one computer program, wherein the at least one computer program, when loaded and executed by a processor of an electronic device, causes the electronic device to perform the method for rendering the image described above.

In another aspect, a computer program or computer program product is further provided. The computer program or computer program product stores at least one computer program, wherein the at least one computer program, when loaded and executed by a processor of an electronic device, causes the electronic device to perform the method for rendering the image described above.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic diagram of an implementation environment for a method for rendering an image according to some embodiments of the present disclosure;

FIG. 2 is a flowchart of a method for rendering an image according to some embodiments of the present disclosure;

FIG. 3 is a schematic diagram illustrating a relationship between other point cloud data and straight-line data according to some embodiments of the present disclosure;

FIG. 4 is a schematic diagram for determining boundary line data according to some embodiments of the present disclosure;

FIG. 5 is a schematic diagram of an object image according to some embodiments of the present disclosure;

FIG. 6 is a schematic diagram of eye vision according to some embodiments of the present disclosure;

FIG. 7 is a schematic diagram of object images with rendered special effects according to some embodiments of the present disclosure;

FIG. 8 is a flowchart of a method for rendering an image according to some embodiments of the present disclosure;

FIG. 9 is a schematic structural diagram of an apparatus for rendering an image according to some embodiments of the present disclosure;

FIG. 10 is a schematic structural diagram of a terminal device according to some embodiments of the present disclosure; and

FIG. 11 is a schematic structural diagram of a server according to some embodiments of the present disclosure.

### DETAILED DESCRIPTION

For clearer descriptions of the objectives, technical solutions, and advantages of the present disclosure, embodiments of the present disclosure are further described in detail below with reference to the accompanying drawings.

FIG. 1 is a schematic diagram of an implementation environment for a method for rendering an image according to some embodiments of the present disclosure. As shown in FIG. 1, the implementation environment includes a terminal device 101, a server 102, and a scanning device 103. The method for rendering the image in the embodiments of the present disclosure is performed by the terminal device 101 or by the terminal device 101 in collaboration with the server 102.

The terminal device 101 is a smart phone, a game console, a desktop computer, a tablet computer, a laptop portable computer, a smart TV, a smart in-car device, an intelligent voice interaction device, a smart home appliance, or the like. The terminal device 101 also includes an interactive device, a head-mounted display device, or the like in the fields of extended reality (XR), augmented reality (AR), virtual reality (VR), mixed reality (MR), or the like. For example, FIG. 1 shows that the terminal device 101 includes an interactive device and a head-mounted display device. The terminal device 101 is communicated with the server 102 via wired or wireless networks, and the terminal device 101 is also communicated with the scanning device 103 via wired or wireless networks.

The server 102 is a single server, a server cluster composed of a plurality of servers, or any one of the cloud computing platform and virtualization center, which is not limited in the embodiments of the present disclosure. In some embodiments, the server 102 is also communicated with the scanning device 103 via wired or wireless networks. The server 102 has functions such as data processing, data storage, and data transmission, which is not limited in the embodiments of the present disclosure. The number of terminal devices 101 and servers 102 is not limited and may be one or more.

With the continuous development of computer technology, extended reality technology is also evolving. Extended reality (XR) technology includes various techniques such as augmented reality (AR), virtual reality (VR), mixed reality (MR), and the like. XR refers to the integration of the real and virtual worlds using computers, creating a virtual environment capable of human-computer interaction. By blending virtual scenes with real scenes, it provides users with an immersive experience, achieving a seamless transition between the virtual and real worlds, thereby creating a sense of ‘immersion’.

AR is a technology that blends virtual information with the real world through techniques such as multimedia, 3D modeling, intelligent interaction, and sensing. Computer-generated text, images, 3D models, music, videos, and other virtual information are simulated and then applied to the real world, achieving an “augmented” real world with complementary virtual information.

VR primarily relies on computer technology, utilizing and combining various high-tech development achievements such as 3D graphics, multimedia, simulation, display, and servo technologies. Using devices like computers, it generates a realistic three-dimensional virtual world that engages multiple sensory experiences including vision, touch, and smell. This creates a sensation of being personally on the scene for the objects in the virtual world.

MR represents a further development of VR technology. By displaying virtual scene information within a real-world setting, and establishing an interactive feedback loop between the real world, virtual world, and objects, MR enhances the sense of realism experienced by the objects involved.

In XR, AR, VR, MR, and other technologies, image rendering techniques play a crucial role. Based on this, how to determine an object image and render the object image becomes a key technology.

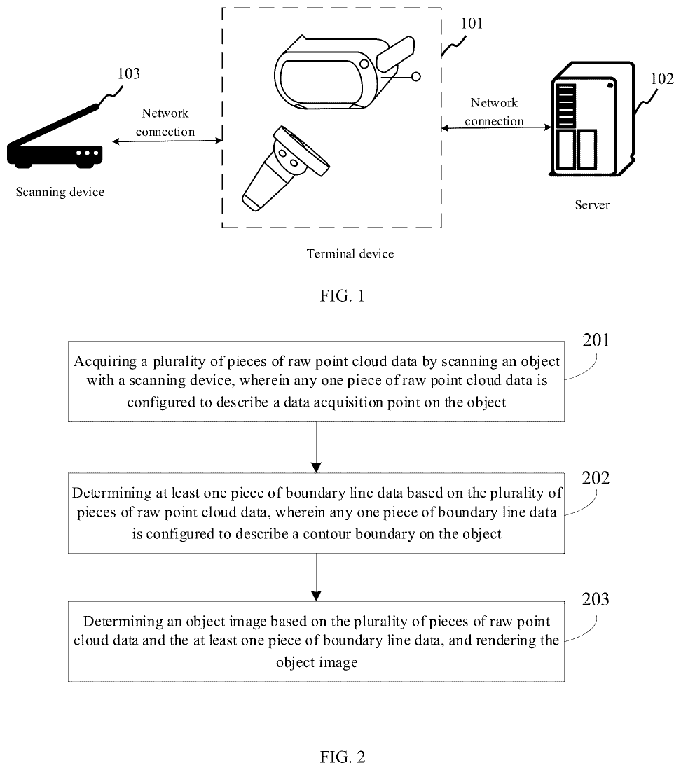

Embodiments of the present disclosure provide a method for rendering an image, which is applied in the above-described implementation environment to determine an object image based on a plurality of pieces of raw point cloud data acquired by scanning an object and to render the object images. For example, referring to the flowchart of a method for rendering an image according to some embodiments of the present disclosure as shown in FIG. 2, for ease of description, the terminal device 101 or the server 102 that performs the method for rendering the image in the embodiments of the present disclosure is referred to as an electronic device. The method can be executed by the electronic device. As shown in FIG. 2, the method includes the following steps.

In step 201, a plurality of pieces of raw point cloud data are acquired by scanning an object with a scanning device, wherein any one piece of raw point cloud data is configured to describe a data acquisition point on the object.

The object in the embodiments of the present disclosure may be any object. For example, the object may be a building, furniture, plant, and the like. The object includes a plurality of data acquisition points, and the data of each data acquisition point on the object is acquired by scanning the object with the scanning device. The data of any data acquisition point is a piece of raw point cloud data, which is configured to describe the data acquisition point.

The embodiments of the present disclosure do not limit the type of the scanning device.

Exemplarily, the scanning device is a device that scans objects based on laser measurement principles and may be referred to as a laser scanning device. A plurality of pieces of raw point cloud data are acquired after scanning the object with the laser scanning device, and one piece of raw point cloud data includes coordinate data of a data acquisition point on the object and reflection intensity data of the data acquisition point, and the like. Alternatively, the scanning device is a device that scans objects based on photogrammetric principles and may be referred to as a photographic scanning device. A plurality of pieces of raw point cloud data are acquired after scanning the object with the photographic scanning device, and one piece of raw point cloud data includes coordinate data of a data acquisition point on the object and color data of the data acquisition point, and the like.

The coordinate data of the data acquisition point includes three-dimensional spatial coordinates, which include horizontal coordinates (commonly represented as x), vertical coordinates (commonly represented as y), and depth coordinates (commonly represented as z). The reflection intensity data of the data acquisition point is used to reflect the intensity of light reflected by the data acquisition point. The color data of the data acquisition point is used to reflect the color of the data acquisition point; optionally, the color data of the data acquisition point is trichromatic data, which includes data from the red (R) channel, green (G) channel, and blue (B) channel.

It should be understood that the scanning device may also be a device that scans objects based on laser measurement principles and photogrammetric principles. In this case, a plurality of pieces of raw point cloud data are acquired after scanning an object with the scanning device, and one piece of raw point cloud data includes coordinate data of a data acquisition point on the object, reflection intensity data of the data acquisition point, and color data of the data acquisition point.

The electronic device in the embodiments of the present disclosure is communicated with the scanning device. In the case that a plurality of pieces of raw point cloud data are acquired after scanning an object with the scanning device, the electronic device acquires the plurality of pieces of raw point cloud data by communicating with the scanning device. The embodiments of the present disclosure do not limit the format of raw point cloud data. Exemplarily, the format of raw point cloud data includes at least one of pts format, asc format, dat format, stl format, imw format, xyz format, and the like.

In step 202, at least one piece of boundary line data is determined based on the plurality of pieces of raw point cloud data, wherein any one piece of boundary line data is configured to describe a contour boundary on the object.

As the raw point cloud data is configured to describe data acquisition points on an object, the appearance of the object is described by a plurality of pieces of raw point cloud data. Typically, an object includes a plurality of substructures, each of which has its corresponding contour boundary.

Taking the example that the object is a building, the building includes substructures such as windows, doors, steps, chimneys, and the like. The windows have their corresponding contour boundaries, and doors also have their corresponding contour boundaries. In other words, there are a plurality of contour boundaries on the object. By processing a plurality of pieces of raw point cloud data, at least one piece of boundary line data configured to describe a contour boundary on the object is determined.

In some embodiments, step 202 includes steps 2021 to 2022.

In step 2021, a plurality of pieces of target point cloud data is acquired by filtering out raw point cloud data satisfying a filtering condition from a plurality of pieces of raw point cloud data.

For any one piece of raw point cloud data, in the case that the piece of raw point cloud data satisfies the filtering condition, the piece of raw point cloud data is filtered out; in the case that the piece of raw point cloud data does not satisfy the filtering condition, the piece of raw point cloud data is retained and considered as a piece of target point cloud data. By filtering out the raw point cloud data satisfying the filtering condition, noise is removed from the raw point cloud data, retaining target point cloud data that describes the object and enhancing the precision of the point cloud data.

In some embodiments, step 2021 includes at least one of the implementations A1 to A3.

In implementation A1, any one piece of raw point cloud data includes coordinate data; the raw point cloud data satisfying the filtering condition includes raw point cloud data with coordinate data outside of a set area.

In the embodiments of the present disclosure, any one piece of raw point cloud data includes coordinate data of a data acquisition point on the object, and the coordinate data includes horizontal, vertical, and depth coordinates. In the case that the coordinate data falls outside of the set area, the raw point cloud data is determined as satisfying the filtering condition and is filtered out; in the case that the coordinate data falls within the set area, the raw point cloud data is retained and determined as target point cloud data.

The embodiments of the present disclosure do not limit the location of the set area.

Exemplarily, the set area is a display area of a display screen of the electronic device or a sub-area of the display area, wherein the display area or the sub-area is configured to display an object image. Filtering out the raw point cloud data with coordinate data outside of the set area ensures that the target point cloud data are data that can be displayed by the electronic device, reducing the quantity of data that needs to be processed by the electronic device and thus improving the efficiency of data processing.

In implementation A2, any one piece of raw point cloud data includes color data; the raw point cloud data satisfying the filtering condition includes raw point cloud data with color data matching a set color.

In the embodiments of the present disclosure, any one piece of raw point cloud data includes color data of a data acquisition point on the object, and the color data includes red channel data, green channel data, and blue channel data. In the case that the color data matches the set color, the raw point cloud data is determined as satisfying the filtering condition and is filtered out; in the case that the color data does not match the set color, the raw point cloud data is retained and determined as target point cloud data.

The embodiments of the present disclosure do not limit the set color. Exemplarily, the set color is the background color of the display page on the electronic device, for example, the set color is white or gray, wherein the display page is a page on which the object image is displayed. Taking the white color as an example, the corresponding trichromatic data of the white color is [255, 255, 255]. Therefore, in the case that color data in any one piece of raw point cloud data has red channel data, green channel data, and blue channel data all being 255, the raw point cloud data is determined as satisfying the filtering condition and is filtered out.

Background-colored point cloud data have a poor display effect on the display page, while non-background-colored point cloud data have a good display effect on the display page. Therefore, filtering out raw point cloud data with color data matching the background color of the display page ensures that target point cloud data are non-background-colored data, which reduces the quantity of data that needs to be processed by the electronic device, and improves the efficiency of data processing, and ensures the display effect.

In implementation A3, any one piece of raw point cloud data includes reflection intensity data; the raw point cloud data satisfying the filtering condition includes raw point cloud data with reflection intensity data less than a set reflection intensity.

In the embodiments of the present disclosure, any one piece of raw point cloud data includes reflection intensity data of a data acquisition point on the object. In the case that the reflection intensity data is less than the set reflection intensity, the raw point cloud data is determined as satisfying the filtering condition and is filtered out; in the case that the reflection intensity data is not less than the set reflection intensity, the raw point cloud data is retained and determined as target point cloud data.

The embodiments of the present disclosure do not limit the set reflection intensity. Exemplarily, the set reflection intensity is data set based on experience or data input by a user.

In the case that the reflection intensity data is less than the set reflection intensity, the raw point cloud data is darker, leading to a poor display effect of the raw point cloud data on the display page. Therefore, by filtering out the raw point cloud data with the reflection intensity data less than the set reflection intensity, the quantity of data that needs to be processed by the electronic device is reduced, the efficiency of data processing is improved, and the display effect is also ensured.

In some embodiments, the raw point cloud data satisfying the filtering condition further includes raw point cloud data with reflection intensity data greater than a reference reflection intensity. In this case, the reference reflection intensity is greater than the set reflection intensity.

In the embodiments of the present disclosure, any one piece of raw point cloud data includes reflection intensity data of a data acquisition point on the object. In the case that the reflection intensity data is greater than the reference reflection intensity, the raw point cloud data is determined as satisfying the filtering condition and is filtered out; in the case that the reflection intensity data is not greater than the reference reflection intensity, the raw point cloud data is retained and determined as target point cloud data.

The embodiments of the present disclosure do not limit the reference reflection intensity. Exemplarily, the reference reflection intensity is data set based on experience or data input by a user.

In the case that the reflection intensity data is greater than the reference reflection intensity, the raw point cloud data is brighter, leading to a poor display effect of the raw point cloud data on the display page. Therefore, by filtering out the raw point cloud data with the reflection intensity data greater than the reference reflection intensity, the quantity of data that needs to be processed by the electronic device is reduced and the efficiency of data processing is improved, while the display effect is also ensured.

In step 2022, at least one piece of boundary line data is determined based on the plurality of pieces of target point cloud data.

In the embodiments of the present disclosure, the target point cloud data is configured to describe a data acquisition point on an object, and the appearance of the object is described with a plurality of pieces of target point cloud data. There are a plurality of contour boundaries on the object. By processing a plurality of pieces of target point cloud data, at least one piece of boundary line data configured to describe a contour boundary on the object is determined.

In some embodiments, step 2022 includes steps B1 to B3.

In step B1, at least two first point cloud clusters are acquired by partitioning the plurality of pieces of target point cloud data, wherein any first point cloud cluster includes at least one piece of target point cloud data.

Any one piece of target point cloud data includes coordinate data of a data acquisition point on the object, color data of the data acquisition point, and reflection intensity data of the data acquisition point. The plurality of pieces of target point cloud data are partitioned into target point cloud data in each first point cloud cluster based on at least one of the coordinate data, the color data, and the reflection intensity data in each piece of target point cloud data.

In some embodiments, step B1 includes steps B1 to B12.

In step B11, for any two pieces of target point cloud data, a distance between the any two pieces of target point cloud data is determined based on coordinate data in the any two pieces of target point cloud data.

By using the formula for distance between two points, the distance between two pieces of target point cloud data is determined based on the coordinate data in the two target point cloud data. Exemplarily, the coordinate data includes horizontal coordinates, vertical coordinates, and depth coordinates, and a difference between the horizontal coordinates, a difference between the vertical coordinates, and a difference between the depth coordinates in the coordinate data in any two pieces of target point cloud data are calculated. The sum of the square of the difference between the horizontal coordinates, the square of the difference between the vertical coordinates, and the square of the difference between the depth coordinates is obtained, followed by taking the square root of the sum, resulting in the distance between the two target point cloud data.

In step B12, in the case that a difference between color data in any two pieces of target point cloud data is less than a first threshold, and a distance between the any two pieces of target point cloud data is less than a second threshold, the any two pieces of target point cloud data are partitioned into the same first point cloud cluster.

The difference between the color data in any two pieces of target point cloud data is determined based on the color data in the two target point cloud data. Exemplarily, color data includes red channel data, green channel data, and blue channel data, and the difference between the red channel data, the difference between the green channel data, and the difference between the blue channel data in any two pieces of target point cloud data are calculated. The difference between the color data in any two pieces of target point cloud data includes the difference between the red channel data, the difference between the green channel data, and the difference between the blue channel data. Alternately, the difference between the color data in any two pieces of target point cloud data is obtained by performing operations such as summing or averaging on the difference between the red channel data, the difference between the green channel data, and the difference between the blue channel data.

In some embodiments, the difference between the color data in any two pieces of target point cloud data includes the difference between the red channel data, the difference between the green channel data, and the difference between the blue channel data, and the first threshold includes a threshold corresponding to the red channel, a threshold corresponding to the green channel, and a threshold corresponding to the blue channel. In the case that the difference between the red channel data is less than the threshold corresponding to the red channel, the difference between the green channel data is less than the threshold corresponding to the green channel, and the difference between the blue channel data is less than the threshold corresponding to the blue channel, the difference between the color data in any two pieces of target point cloud data is less than the first threshold. In the case that the difference between the red channel data is not less than the threshold corresponding to the red channel, and/or the difference between the green channel data is not less than the threshold corresponding to the green channel, and/or the difference between the blue channel data is not less than the threshold corresponding to the blue channel, the difference between the color data in any two pieces of target point cloud data is not less than the first threshold.

In the case that the difference between the color data in any two pieces of target point cloud data is less than the first threshold, and the distance between the any two pieces of target point cloud data is less than the second threshold, the any two pieces of target point cloud data are partitioned into the same first point cloud cluster. In the case that the difference between the color data in any two pieces of target point cloud data is not less than the first threshold, and/or the distance between the any two pieces of target point cloud data is not less than the second threshold, the any two pieces of target point cloud data are partitioned into different first point cloud clusters. The embodiments of the present disclosure do not limit the way of determining the first threshold and the second threshold. Exemplarily, the first threshold and the second threshold are data set based on experience or data input by a user.

Using steps B11 to B12, a plurality of pieces of target point cloud data are partitioned into at least two first point cloud clusters, and each first point cloud cluster includes at least one piece of target point cloud data.

In step B2, for any two first point cloud clusters, boundary line data between the any two first point cloud clusters is determined based on each piece of target point cloud data in the any two first point cloud clusters.

In the embodiments of the present disclosure, each piece of target point cloud data in one first point cloud cluster is considered to be data of each of the data acquisition points on the same substructure of an object. As each substructure has its corresponding contour boundary, the boundary line data between any two first point cloud clusters is determined based on each piece of target point cloud data in the any two first point cloud clusters. The boundary line data between the two first point cloud clusters is considered to be a contour boundary between two adjacent substructures on the object.

In some embodiments, step B2 includes steps B21 to B24.

In step B21, a plurality of pieces of reference point cloud data are determined from each piece of target point cloud data in any two first point cloud clusters, wherein a distance between each piece of the reference point cloud data and one of the any two first point cloud clusters is less than a third threshold, and a distance between each piece of the reference point cloud data and the other of the any two first point cloud clusters is less than a fourth threshold.

The center of any first point cloud cluster is determined based on each piece of target point cloud data in the first point cloud cluster. In some embodiments, for each piece of target point cloud data in any first point cloud cluster, the horizontal coordinate of the center of the first point cloud cluster is obtained by calculating the average value of the horizontal coordinates in the coordinate data in each piece of target point cloud data. Similarly, the vertical coordinate of the center of the first point cloud cluster is obtained by calculating the average value of the vertical coordinates in the coordinate data in each piece of target point cloud data; the depth coordinate of the center of the first point cloud cluster is obtained by calculating the average value of the depth coordinates in the coordinate data in each piece of target point cloud data.

For any one piece of target point cloud data in each piece of target point cloud data in any two first point cloud clusters, the distance between the piece of target point cloud data and the center of one of the any two first point cloud clusters is calculated based on the coordinate data in the piece of target point cloud data and the center of the first point cloud cluster. That is, the distance between the piece of target point cloud data and the first point cloud cluster is acquired by the calculation.

In some embodiments, by using the formula for distance between two points, the distance between the piece of target point cloud data and the center of a first point cloud cluster is calculated based on the coordinate data in the piece of target point cloud data and the center of the first point cloud cluster. Exemplarily, the difference in the horizontal coordinates between the horizontal coordinate in the coordinate data in a piece of target point cloud data and the horizontal coordinate of the center of a first point cloud cluster, the difference in the vertical coordinates between the vertical coordinate in the coordinate data in the piece of target point cloud data and the vertical coordinate of the center of the first point cloud cluster, and the difference in the depth coordinates between the depth coordinate in the coordinate data in the piece of target point cloud data and the depth coordinate of the center of the first point cloud cluster are calculated. The sum of the squares of the difference between the horizontal coordinates, the square of the difference between the vertical coordinates, and the square of the difference between the depth coordinates is obtained, followed by taking the square root of the sum, resulting in the distance between the piece of target point cloud data and the first point cloud cluster.

In the case that the distance between any one piece of target point cloud data in any two first point cloud clusters and one of the two first point cloud clusters is less than a third threshold, and the distance between the piece of target point cloud data and the other of the two first point cloud clusters is less than a fourth threshold, then the piece of target point cloud data is considered as a piece of reference point cloud data. In the case that the distance between any one piece of target point cloud data in any two first point cloud clusters and one of the two first point cloud clusters is not less than a third threshold, and the distance between the piece of target point cloud data and the other of the two first point cloud clusters is not less than a fourth threshold, then the piece of target point cloud data is not considered as a piece of reference point cloud data.

The embodiments of the present disclosure do not limit the third threshold and the fourth threshold. Exemplarily, the distances between each piece of target point cloud data in a first point cloud cluster and the center of the first point cloud cluster are determined based on the coordinate data of each piece of target point cloud data in the first point cloud cluster and the center of the first point cloud cluster, and the maximum distance among these distances is determined and considered as dimension data of the first point cloud cluster. In the embodiments of the present disclosure, the distance between a piece of reference point cloud data and a first point cloud cluster is less than a third threshold, and the third threshold is determined based on the dimension data of the first point cloud cluster. For example, the third threshold is greater than the dimension data of the first point cloud cluster and less than a set multiple (such as 1.1 times, 1.3 times, etc.) of the dimension data of the first point cloud cluster. Similarly, the distance between a piece of reference point cloud data and another first point cloud cluster is less than a fourth threshold, and the fourth threshold is determined based on the dimension data of the first point cloud cluster. For example, the fourth threshold is greater than the dimension data of the first point cloud cluster and less than a set multiple of the dimension data of the first point cloud cluster.

In step B22, for any two pieces of reference point cloud data, straight-line data is determined based on the any two pieces of reference point cloud data.

By using the two-point straight-line formula, the straight-line data is determined based on the coordinate data in any two pieces of reference point cloud data. That is, the straight-line data is configured to describe a straight-line determined based on coordinate data in the any two pieces of target point cloud data. The straight-line data is two-dimensional straight-line data, and the format of the two-dimensional straight-line data is expressed as y=Ax+B, or as Ax+By+C=0. The straight-line data is also three-dimensional straight-line data, and the format of the three-dimensional straight-line data is expressed as Ax+By+Cz+D=0. Here, x represents the horizontal coordinate, y represents the vertical coordinate, z represents the depth coordinate, and A, B, C, and D represent four parameters.

In step B23, the distances between the other point cloud data and the straight-line data are determined, wherein the other point cloud data are target point cloud data from each piece of target point cloud data in any two first point cloud clusters except the any two pieces of reference point cloud data.

By using the formula for distance between a point and a straight line, the distances between the other point cloud data and the straight-line data are determined based on the coordinate data in the other point cloud data and the straight-line data. In the case that the straight-line data is a two-dimensional straight-line data, the distances between the other point cloud data and the straight-line data are calculated as d=|(Ax+By+C)/(\sqrt{A²+B²})|; in the case that the straight-line data is a three-dimensional straight-line data, the distances between the other point cloud data and the straight-line data are represented as d=|(Ax+By+Cz+D)/(\sqrt{A²+B²+C²})|. Here, x represents the horizontal coordinates of the other point cloud data, y represents the vertical coordinates of the other point cloud data, z represents the depth coordinates of the other point cloud data, and A, B, C, and D represent parameters of the straight-line data.

In step B24, in the case that the quantity of other point cloud data with distances to the straight-line data less than a fifth threshold satisfies a quantity condition, the straight-line data is determined as the boundary line data between any two first point cloud clusters.

After calculating the distances between the other point cloud data and the straight-line data, the quantity of other point cloud data with distances less than the fifth threshold to the straight-line data is counted. In the case that the quantity satisfies the quantity condition, the straight-line data is determined as the boundary line data between any two first point cloud clusters. In the case that the quantity does not satisfy the quantity condition, the straight-line data is not considered as the boundary line data between any two first point cloud clusters.

The embodiments of the present disclosure do not limit the quantity condition. Exemplarily, the quantity condition is that the quantity exceeds a set multiple of the total number of other point cloud data, with the set multiple being greater than 0 and less than 1. Alternatively, in the case that a plurality of pieces of straight-line data exist, and the quantity of other point cloud data with distances to each piece of the straight-line data less than the fifth threshold is counted, the quantity condition is the maximum quantity among the quantities of other point cloud data with distances to each piece of straight-line data less than the fifth threshold.

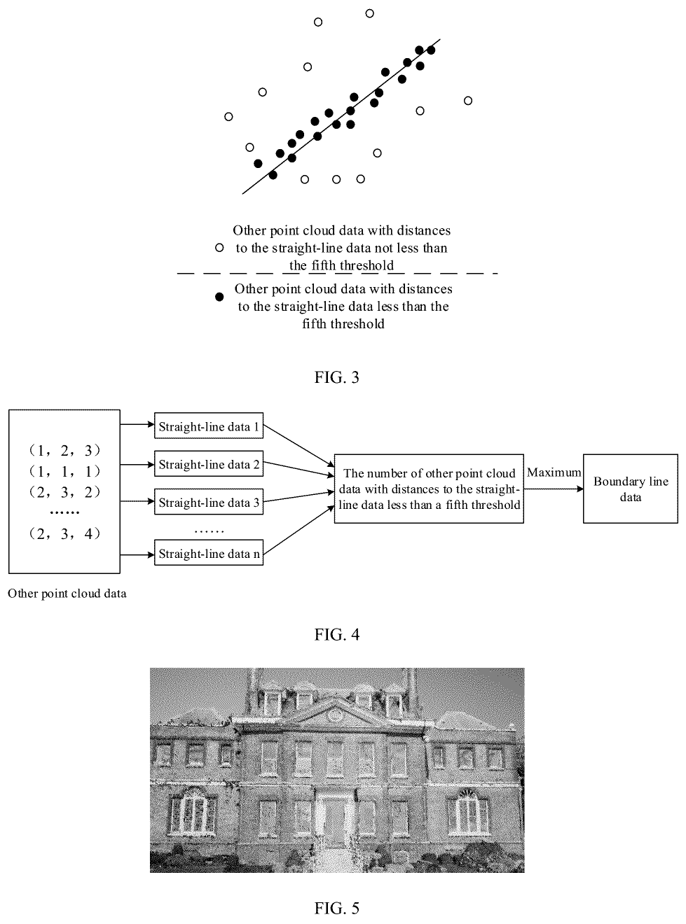

Referring to FIG. 3, FIG. 3 is a schematic diagram illustrating a relationship between other point cloud data and straight-line data according to some embodiments of the present disclosure. As can be seen from FIG. 3, the quantity of other point cloud data with distances to the straight-line data less than the fifth threshold is greater than the quantity of other point cloud data with distances to the straight-line data not less than the fifth threshold.

Other point cloud data with distances to the straight-line data less than the fifth threshold are referred to as inliers, and other point cloud data with distances to the straight-line data not less than the fifth threshold are referred to as outliers. Inliers are the assumed correct data in the random sample consensus (RANSAC) algorithm, and outliers are the assumed anomalous data (referred to as noise data) in the RANSAC algorithm.

The RANSAC algorithm assumes a given set of correct data to calculate a model that fits these correct data. The core idea of the RANSAC algorithm is randomness and assumption.

Randomness involves randomly selecting sample data based on the probability of the occurrence of correct data and simulating an approximation to obtain a correct result according to the law of large numbers. Assumption involves assuming that the selected sample data are all correct data and using these correct data to evaluate whether other data satisfy the model to score the obtained correct result. The RANSAC algorithm is widely applied in computer vision and mathematical fields. The models determined by the algorithm may be lines, planes, computed images, transformation matrices between point clouds, fundamental matrices, and other types of models. The RANSAC algorithm has high robustness and computational efficiency.

Referring to FIG. 4, FIG. 4 is a schematic diagram for determining boundary line data according to some embodiments of the present disclosure. In the embodiments of the present disclosure, the quantity of other point cloud data is multiple, and any one piece of other point cloud data includes coordinate data. A plurality of pieces of coordinate data are shown in FIG. 4, which are (1, 2, 3), (1, 1, 1), (2, 3, 2), . . . , (2, 3, 4), respectively. The distances between the other point cloud data and the straight-line data 1 to n are determined based on the coordinate data in the other point cloud data and the straight-line data 1 to n. The quantity of other point cloud data with distances to each piece of straight-line data less than the fifth threshold is tallied, and the maximum quantity among the quantities is selected. The straight-line data corresponding to the maximum quantity is determined as the boundary line data.

Using steps B21 to B24, the boundary line data between every two first point cloud clusters are determined.

In step B3, in the case that the at least two first point cloud clusters satisfy a partitioning condition, the boundary line data between every two first point cloud clusters are determined as at least one piece of boundary line data.

The embodiments of the present disclosure do not limit the partitioning condition for at least two first point cloud clusters to satisfy. Exemplarily, in the case that a plurality of pieces of target point cloud data are partitioned to obtain at least two first point cloud clusters, the partitioning frequency is 1. In this case, the condition for at least two first point cloud clusters to satisfy the partitioning condition is that the partitioning frequency, in the case of partitioning to obtain at least two first point cloud clusters, reaches a set number, which is 1 in this case. Alternatively, the condition for at least two first point cloud clusters to satisfy the partitioning condition is that the quantity of first point cloud clusters reaches a set number.

In the case that at least two first point cloud clusters satisfy the partitioning condition, the boundary line data between every two first point cloud clusters are determined as each piece of boundary line data. In this case, step 203 is performed.

In some embodiments, steps B4 to B6 are further included after step B2.

In step B4, in the case that the at least two first point cloud clusters do not satisfy the partitioning condition, for any first point cloud cluster, each piece of target point cloud data in the any first point cloud cluster is partitioned to acquire at least two second point cloud clusters, with any second point cloud cluster including at least one piece of target point cloud data.

In the case that at least two first point cloud clusters do not satisfy the partitioning condition, for example, the partitioning frequency, in the case of partitioning to obtain at least two first point cloud clusters, does not reach the set number (in this case, the set number is greater than 1, such as 10), or the quantity of first point cloud clusters does not reach the set number. Each first point cloud cluster is further partitioned to obtain each second point cloud cluster. Any first point cloud cluster is partitioned into at least one second point cloud cluster, with any second point cloud cluster including at least one piece of target point cloud data.

In some embodiments, the “acquiring at least two second point cloud clusters by partitioning each piece of target point cloud data in any first point cloud cluster” in step B4 includes: determining, for any two pieces of target point cloud data in any first point cloud cluster, a distance between the any two pieces of target point cloud data based on the coordinate data in the any two pieces of target point cloud data; partitioning, in the case that a difference between the color data in any two pieces of target point cloud data is less than the sixth threshold, and a distance between the any two pieces of target point cloud data is less than the seventh threshold, the any two pieces of target point cloud data into the same second point cloud cluster. The way of acquiring at least two second point cloud clusters through partitioning is described in steps B11 to B12, which has similar implementation principles and is not repeated herein.

In step B5, for any two second point cloud clusters, boundary line data between the any two second point cloud clusters is determined based on the each piece of target point cloud data in the any two second point cloud clusters.

Each piece of target point cloud data in a second point cloud cluster is considered to be data of each of data acquisition points on the same substructure of an object. As each substructure has its corresponding contour boundary, the boundary line data between any two second point cloud clusters is determined based on each piece of target point cloud data in the any two second point cloud clusters. The boundary line data between the two second point cloud clusters is considered to be a contour boundary between two adjacent substructures on the object. The implementation of step B5 is described in steps B21 to B24, which has similar implementation principles and is not repeated herein.

In step B6, in the case that each second point cloud cluster satisfies the partitioning condition, boundary line data between every two first point cloud clusters and boundary line data between every two second point cloud clusters are determined as at least one piece of boundary line data.

The embodiments of the present disclosure do not limit the partitioning condition for each second point cloud cluster to satisfy. Exemplarily, in the case that each second point cloud cluster is obtained through partitioning, the partitioning frequency is 2. In this case, the condition for each second point cloud cluster to satisfy the partitioning condition is that the partitioning frequency, in the case of partitioning to obtain each second point cloud cluster, reaches a set number, which is 2 in this case. Alternatively, the condition for each second point cloud cluster to satisfy the partitioning condition is that the quantity of second point cloud clusters reaches a set number.

In the case that each second point cloud cluster satisfies the partitioning condition, the boundary line data between every two first point cloud clusters and the boundary line data between every two second point cloud clusters are determined as the boundary line data. In this case, step 203 is performed.

In the case that each second point cloud cluster does not satisfy the partitioning condition, for any second point cloud cluster, each piece of target point cloud data in the any second point cloud cluster is partitioned to obtain at least two third point cloud clusters, with any third point cloud cluster including at least one piece of target point cloud data. For any two third point cloud clusters, boundary line data between the any two third point cloud clusters is determined based on each piece of target point cloud data in the any two third point cloud clusters. In the case that each third point cloud cluster satisfies the partitioning condition, the boundary line data between every two first point cloud clusters, the boundary line data between every two second point cloud clusters, and the boundary line data between every two third point cloud clusters are determined as at least one piece of boundary line data. In the case that each third point cloud cluster does not satisfy the partitioning condition, each third point cloud cluster is further partitioned. This process continues until the partitioning condition is satisfied, resulting in obtaining at least one piece of boundary line data.

In step 203, an object image is determined based on the plurality of pieces of raw point cloud data and at least one piece of boundary line data, and the object image is rendered.

In the case that a plurality of pieces of raw point cloud data and at least one piece of boundary line data are obtained, it is equivalent to obtaining an object image. The object image includes a plurality of pieces of raw point cloud data and the boundary line data. Referring to FIG. 5, FIG. 5 is a schematic diagram of an object image according to some embodiments of the present disclosure. As can be seen from FIG. 5, the object image includes a plurality of pieces of raw point cloud data and the boundary line data.

In some embodiments, the “determining the object image based on the plurality of pieces of raw point cloud data and the at least one piece of boundary line data” in step 203 includes: determining the object image based on the plurality of pieces of target point cloud data and the at least one piece of boundary line data.

As mentioned above, a plurality of pieces of target point cloud data are obtained by filtering out the raw point cloud data satisfying the filtering condition from a plurality of pieces of raw point cloud data. In this case, after at least one piece of boundary line data is determined, it is equivalent to determining the object image. The object image includes a plurality of pieces of target point cloud data and the boundary line data.

After obtaining the object image, the electronic device renders the object image and displays the object image through a display screen. In some embodiments, “rendering the object image” in step 203 includes: acquiring an offset between a reference point of a display screen on a head-mounted display device and a reference point of the object image; acquiring an offset object image by offsetting the object image based on the offset; rendering the offset object image on the display screen.

In the embodiments of the present disclosure, the electronic device is a head-mounted display device in XR, AR, VR, MR, and similar technologies. A head-mounted display device includes at least one display screen, for example, some head-mounted display devices include a left-eye display screen and a right-eye display screen.

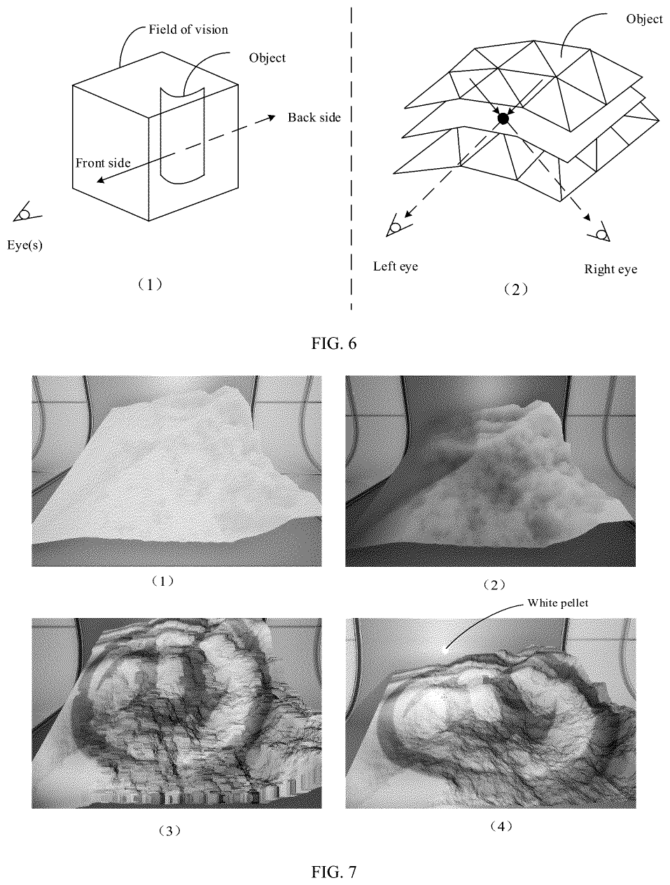

Generally, there are differences between objects seen by the left eye and objects seen by the right eye. Referring to FIG. 6, FIG. 6 is a schematic diagram of eye vision according to some embodiments of the present disclosure. As can be seen from FIG. 6 (1), the field of vision of the eye is limited. For objects within the field of vision, the eye can observe the front side of the object (i.e., the side of the object facing the eye). In the case that an object is opaque, the eye cannot observe the back side of the object (i.e., the side of the object facing distal from the eye). As can be seen from FIG. 6 (2), there are differences between objects seen by the left eye and objects seen by the right eye. Taking the center point of an object as an example, when the left eye sees the object, it is easy to observe the left side of the object (i.e., the side proximal to the left eye), causing the center point to be imaged slightly to the right in the left eye; similarly, when the right eye sees the object, it is easy to observe the right side of the object (i.e., the side proximal to the right eye), causing the center point to be imaged slightly to the left in the right eye. Based on the principles mentioned above, in XR, AR, VR, MR, and similar technologies, it is necessary to offset the object image to display the offset image on the display screen of the head-mounted display device. This ensures that the displayed image on the display screen better conforms to the principle of human eye vision.

In some embodiments, the electronic device acquires the offset between the reference point on any display screen of the head-mounted display device and the reference point on the object image. The offset may be data input by a user or data set based on experience. For example, the offset between the reference points on the left-eye display screen, the right-eye display screen, and the reference points on the object image is set to 30. The embodiments of the present disclosure do not limit the reference point, exemplarily, the reference point is a center point or any vertex.

In the embodiments of the present disclosure, for a point on the object, the condition that the point is observed by the eye along the light propagation direction (i.e., the projection direction) and follows Gaussian distribution is satisfied. Assuming that the object image is fk(u, v), in the case that the light reaches the position f from the position (u, v) of the eye along the propagation direction at the k-th viewing angle of the eye, the object image seen by the eye (i.e., the offset object image) is fk\hat{ }(u, v). In this case, the following formula (1) is applicable.

$$P ( fk ( u , v ) \vert {fk}^{\hat{}} ( u , v ) ) = ck ( u , v ) exp [ - 12 ( {fk}^{\hat{}} ( u , v ) - fk ( u , v ) σ k ( u , v ) ) 2 ] P ( fk ( u , v ) \vert {fk}^{\hat{}} ( u , v ) ) = ck ( u , v ) exp f 0 [ - 12 ( {fk}^{\hat{}} ( u , v ) - fk ( u , v ) σ k ( u , v ) ) 2 ] \qquad formula ( 1 )$$

wherein, P(fk(u, v)|fk\hat{ }(u, v)) represents the probability of obtaining fk(u, v) given fk\hat{ }(u, v). ck(u, v) represents the offset. exp represents the exponential function with the base of the natural constant e. σk(u, v) represents the weight coefficient. f0 represents a hyperparameter.

Subsequently, the object image is offset to acquire the offset image based on the offset between the reference point on any display screen and the reference point on the object image. In the case that the offset is positive, the object image is shifted in the positive direction of the x-axis (e.g., the positive direction of the x-axis is the right direction); in the case the offset is negative, the object image is shifted in the negative direction of the x-axis (e.g, the negative direction of the x-axis is the left direction). Then, the electronic device renders the offset image on the display screen, thereby achieving the display of the offset object image on the display screen.

In some embodiments, the electronic device receives interactive instructions. The interactive instructions are input through gestures, or input based on keyboard and mouse (KM) applications, or input based on touch-point (TP) devices. Then, the electronic device renders special effects on the object image or the offset object image that are relevant to the interactive instructions.

Referring to FIG. 7, FIG. 7 is a schematic diagram of object images with rendered special effects according to some embodiments of the present disclosure. In FIG. 7 (1), color effects are rendered on the object image; in FIG. 7 (2), gradient fog effects are rendered on the object image, in FIG. 7 (3); granular effects are rendered on the object image, and in FIG. 7 (4), granular effects are rendered on the object image with a white pellet being controlled to move in the direction indicated by the interactive instruction.

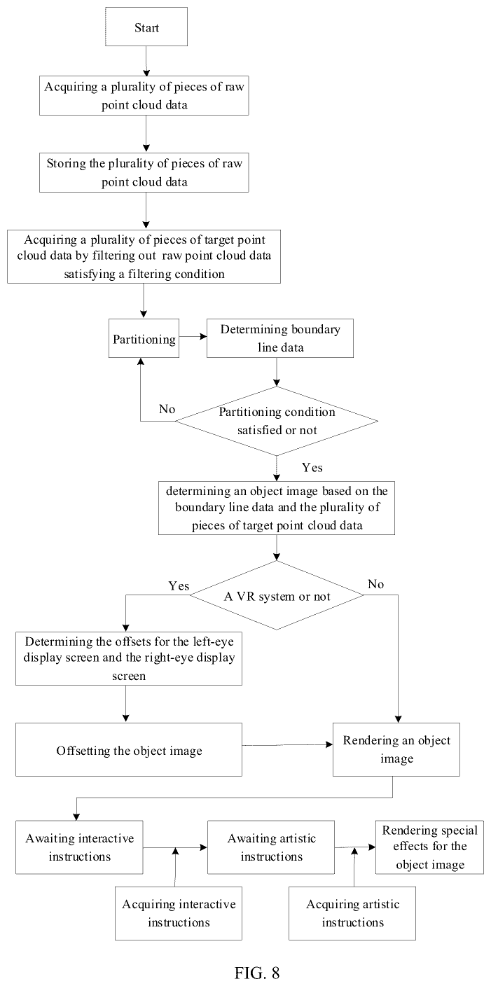

Now referring to FIG. 8, FIG. 8 is a flowchart of a method for rendering an image according to some embodiments of the present disclosure. In the embodiments of the present disclosure, a plurality of pieces of raw point cloud data is acquired and stored. A plurality of pieces of target point cloud data are acquired by filtering out raw point cloud data satisfying a filtering condition from a plurality of pieces of raw point cloud data. Then, the plurality of pieces of target point cloud data are partitioned to acquire each point cloud cluster, and boundary line data between every two point cloud clusters are determined based on each piece of target point cloud data in every two point cloud clusters. In the case that a partitioning condition is not satisfied, the process of “acquiring each point cloud cluster by partitioning the plurality of pieces of target point cloud data and determining the boundary line data between every two point cloud clusters based on each piece of target point cloud data in every two point cloud clusters” is repeated. In the case that the partitioning condition is satisfied, the object image is determined based on the boundary line data and the plurality of pieces of target point cloud data.

In the case that the electronic device is a VR system, then the offsets for the left-eye display screen and the right-eye display screen are determined. The object image is offset based on the offset for the left-eye display screen, and the offset object image is rendered on the left-eye display screen. The object image is offset based on the offset for the right-eye display screen, and the offset object image is rendered on the right-eye display screen. In the case that the electronic device is not a VR system, then the object image is directly rendered.

After the electronic device renders the object image, the electronic device awaits interactive instructions. Upon receiving interactive instructions, the process of awaiting artistic instructions is initiated. Upon receiving artistic instructions, special effects are rendered for the object image.

It should be noted that the information (including but not limited to user device information, user personal information, and the like), data (including but not limited to data used for analysis, stored data, displayed data, and the like), and signals involved in the present disclosure are all obtained with user authorization or have been fully authorized by all relevant parties. Additionally, the collection, use, and processing of relevant data must adhere to the relevant laws, regulations, and standards of the respective regions. For example, the raw point cloud data and interactive instructions involved in the present disclosure are obtained under full authorization.

In the method mentioned-above, the plurality of pieces of raw point cloud data are acquired by scanning an object with a scanning device and the boundary line data configured to describe the contour boundary on the object are determined based on the plurality of pieces of raw point cloud data, such that the object image is determined based on the plurality of pieces of raw point cloud data and the boundary line data, and the object image is rendered. As the object image is determined based on the plurality of pieces of raw point cloud data acquired through object scanning, the object image accurately reflects the object, resulting in a high level of accuracy.

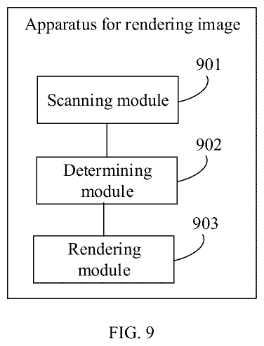

FIG. 9 is a schematic structural diagram of an apparatus for rendering an image according to some embodiments of the present disclosure. As shown in FIG. 9, the apparatus includes:
a scanning module 901 configured to acquire a plurality of pieces of raw point cloud data by scanning an object with a scanning device, wherein any one piece of raw point cloud data is configured to describe a data acquisition point on the object;
a determining module 902 configured to determine at least one piece of boundary line data based on the plurality of pieces of raw point cloud data, wherein any one piece of boundary line data is configured to describe a contour boundary on the object, wherein
the determining module 902 is further configured to determine an object image based on the plurality of pieces of raw point cloud data and the at least one piece of boundary line data; and
a rendering module 903 configured to render the object image.

In some embodiments, the determining module 902 is configured to acquire a plurality of pieces of target point cloud data by filtering out raw point cloud data satisfying a filtering condition from the plurality of pieces of raw point cloud data; determine at least one piece of boundary line data based on the plurality of pieces of target point cloud data; and determine an object image based on the plurality of pieces of target point cloud data and the at least one piece of boundary line data.

In some embodiments, any one piece of raw point cloud data includes coordinate data; the raw point cloud data satisfying the filtering condition includes raw point cloud data with coordinate data outside of a set area;
and/or, any one piece of raw point cloud data includes color data; the raw point cloud data satisfying the filtering condition includes raw point cloud data with color data matching a set color;
and/or, any one piece of raw point cloud data includes reflection intensity data; the raw point cloud data satisfying the filtering condition includes raw point cloud data with reflection intensity data less than a set reflection intensity.

In some embodiments, the determining module 902 is configured to acquire at least two first point cloud clusters by partitioning the plurality of pieces of target point cloud data, wherein any first point cloud cluster includes at least one piece of target point cloud data; determine, for any two first point cloud clusters, boundary line data between the any two first point cloud clusters based on each piece of target point cloud data in the any two first point cloud clusters; and determine, in a case that the at least two first point cloud clusters satisfy a partitioning condition, boundary line data between every two first point cloud clusters as at least one piece of boundary line data.

In some embodiments, the determining module 902 is configured to determine, for any two pieces of target point cloud data, a distance between the any two pieces of target point cloud data based on the coordinate data in the any two pieces of target point cloud data; and partition, in a case that the difference between the color data in the any two pieces of target point cloud data is less than the first threshold and a distance between the any two pieces of target point cloud data is less than the second threshold, the any two pieces of target point cloud data into the same first point cloud cluster.

In some embodiments, the determining module 902 is configured to determine a plurality of pieces of reference point cloud data from the each piece of target point cloud data in the any two first point cloud clusters, wherein a distance between each piece of the reference point cloud data and one of the any two first point cloud clusters is less than the third threshold, and a distance between each of the reference point cloud data and the other of the any two first point cloud clusters is less than the fourth threshold; determine, for any two pieces of reference point cloud data, straight-line data based on the any two pieces of reference point cloud data; determine distances between other point cloud data and the straight-line data, wherein the other point cloud data are target point cloud data from the each piece of target point cloud data in the any two first point cloud clusters except the any two pieces of reference point cloud data; and determine, in a case that a quantity of other point cloud data with distances to the straight-line data less than the fifth threshold satisfies the quantity condition, the straight-line data as the boundary line data between the any two first point cloud clusters.

In some embodiments, the determining module 902 is further configured to acquire at least two second point cloud clusters by partitioning, for any first point cloud cluster, in a case that the at least two first point cloud clusters do not satisfy the partitioning condition, each piece of target point cloud data in the any first point cloud cluster, wherein any second point cloud cluster includes at least one piece of target point cloud data; determine, for any two second point cloud clusters, boundary line data between the any two second point cloud clusters based on each piece of target point cloud data in the any two second point cloud clusters; and determine, in a case that each second point cloud cluster satisfies the partitioning condition, boundary line data between every two first point cloud clusters and the boundary line data between every two second point cloud clusters as at least one piece of boundary line data.

In some embodiments, the rendering module 903 is configured to acquire an offset between a reference point of a display screen on a head-mounted display device and a reference point of the object image; acquire an offset object image by offsetting the object image based on the offset; and rendering the offset object image on the display screen.

In the apparatus mentioned above, the plurality of pieces of raw point cloud data are acquired by scanning an object with a scanning device, and the boundary line data configured to describe the contour boundary on the object are determined based on the plurality of pieces of raw point cloud data, such that the object image is determined based on the plurality of pieces of raw point cloud data and the boundary line data, and the object image is rendered. As the object image is determined based on the plurality of pieces of raw point cloud data acquired by scanning the object, the object image reflects the object accurately, resulting in a high level of accuracy.

It should be understood that, in the case that the above apparatus according to FIG. 9 implements the functions thereof, the division of the functional modules is merely exemplary. In practical application, the above functions can be assigned to different functional modules according to needs, that is, the internal structure of the device may be divided into different functional modules, to implement all or a part of the above functions. In addition, the apparatus and the method according to the above embodiments belong to the same concept, and specific implementation processes thereof are described in the method embodiments in detail, and are not repeated herein.

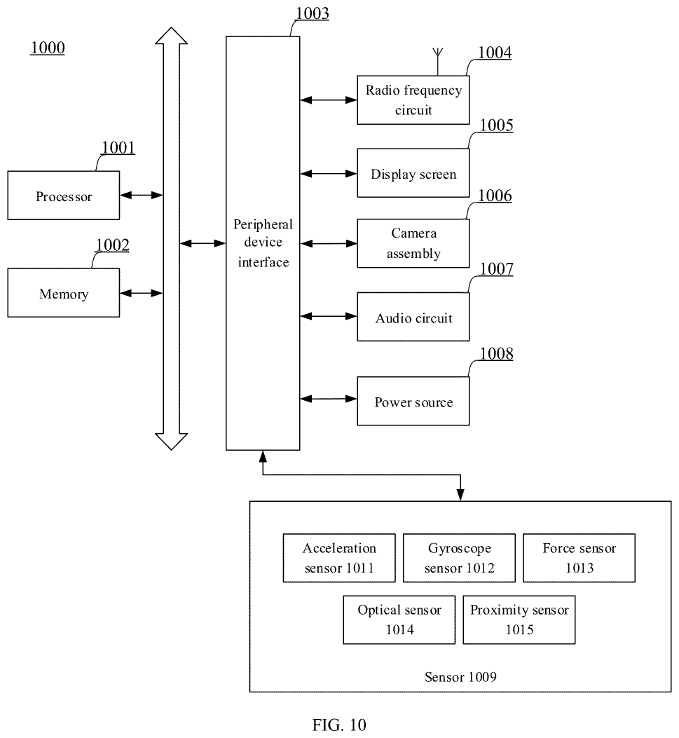

FIG. 10 shows a structural block diagram of a terminal device 1000 according to some embodiments of the present disclosure. The terminal device 1000 includes a processor 1001 and a memory 1002.

The processor 1001 includes one or more processing cores, such as a 4-core processor and an 8-core processor. The processor 1001 is implemented by at least one of hardware forms of a digital signal processor (DSP), a field-programmable gate array (FPGA), and a programmable logic array (PLA). The processor 1001 also includes a main processor and a coprocessor. The main processor is a processor for processing data in an awake state, and is also referred to as a central processing unit (CPU). The coprocessor is a low-power-consumption processor for processing the data in a standby state. In some embodiments, the processor 1001 is integrated with a graphics processing unit (GPU), which is configured to render and draw the content that needs to be displayed on a display screen. In some embodiments, the processor 1001 further includes an artificial intelligence (AI) processor for processing computational operations related to machine learning.

The memory 1002 includes one or more computer-readable storage media, which is non-transitory. The memory 1002 further includes a high-speed random access memory, as well as a non-volatile memory, such as one or more magnetic disk storage devices and flash storage devices.

In some embodiments, a non-transitory computer-readable storage medium in the memory 1002 is configured to store at least one program. The at least one program, when executed by the processor 1001, causes the processor 1001 to perform the method for rendering the image in the embodiments of the present disclosure.

In some embodiments, the terminal device 1000 further optionally includes a peripheral device interface 1003 and at least one peripheral device. The processor 1001, the memory 1002, and the peripheral device interface 1003 are connected via buses or signal lines. Each peripheral device is connected to the peripheral device interface 1003 via a bus, signal line, or a circuit board. In some embodiments, the peripheral devices include at least one of a radio frequency circuit 1004, a display screen 1005, a camera assembly 1006, an audio circuit 1007, and a power source 1008.

The peripheral device interface 1003 is configured to connect at least one peripheral device associated with an input/output (I/O) to the processor 1001 and the memory 1002. In some embodiments, the processor 1001, the memory 1002, and the peripheral device interface 1003 are integrated on the same chip or circuit board. In some other embodiments, any one or two of the processor 1001, the memory 1002, and the peripheral device interface 1003 are implemented on a separate chip or circuit board, which is not limited in the embodiments of the present disclosure.

The radio frequency circuit 1004 is configured to receive and transmit a radio frequency (RF) signal, which is also referred to as an electromagnetic signal. The radio frequency circuit 1004 is communicated with a communication network and other communication devices via electromagnetic signals. The radio frequency circuit 1004 converts an electrical signal into an electromagnetic signal for transmission or converts the received electromagnetic signal into an electrical signal. In some embodiments, the radio frequency circuit 1004 includes an antenna system, an RF transceiver, one or more amplifiers, a tuner, an oscillator, a digital signal processor, a coder/decoder (codec) chipset, a subscriber identity module card, and the like. The radio frequency circuit 1004 is communicated with other terminals via at least one wireless communication protocol. The wireless communication protocol includes, but is not limited to, WWW network, a metropolitan area network, an intranet, various generations of mobile communication networks (2G, 3G, 4G, and 5G), a wireless local area network, and/or a wireless fidelity (Wi-Fi) network. In some embodiments, the radio frequency circuit 1004 further includes a near field communication (NFC) related circuit, which is not limited in the embodiments of the present disclosure.

The display screen 1005 is configured to display a user interface (UI). The UI includes graphics, text, icons, videos, and any combination thereof. In the case that the display screen 1005 is a touch display screen, the display screen 1005 also has the capacity to acquire a touch signal on or over a surface of the display screen 1005. The touch signal is input to the processor 1001 as a control signal for processing. In this case, the display screen 1005 is also configured to provide virtual buttons and/or virtual keyboards, which are also referred to as soft buttons and/or soft keyboards. In some embodiments, there is one display screen 1005 disposed on a front panel of the terminal device 1000; in some other embodiments, there are at least two display screens 1005 disposed on different surfaces of the terminal device 1000 respectively or in a folded design. In some still other embodiments, the display screen 1005 is a flexible display screen disposed on a curved surface or a folded surface of the terminal device 1000. Moreover, the display screen 1005 may have an irregular shape other than a rectangle, that is, an irregular-shaped screen. The display screen 1005 is prepared by using a material such as a liquid crystal display (LCD) or an organic light-emitting diode (OLED).

The camera assembly 1006 is configured to capture images or videos. Optionally, the camera assembly 1006 includes a front camera and a rear camera. Generally, the front camera is disposed on the front panel of the terminal and the rear camera is disposed on a back side of the terminal. In some embodiments, there are at least two rear cameras, and each of the at least two rear cameras is any one of a main camera, a depth-of-field camera, a wide-angle camera, and a telephoto camera, to realize a background blurring function realized by fusion of the main camera and the depth-of-field camera, panoramic shooting and virtual reality (VR) shooting functions by fusion of the main camera and the wide-angle camera, or other fusion shooting functions. In some embodiments, the camera assembly 1006 further includes a flashlight. The flashlight is a mono-color temperature flashlight or a two-color temperature flashlight. The two-color temperature flashlight is a combination of a warm flashlight and a cold flashlight, and can be used for light compensation at different color temperatures.

The audio circuit 1007 includes a microphone and a loudspeaker. The microphone is configured to acquire sound waves of users and the environment, and convert the sound waves into electrical signals which are input into the processor 1001 for processing, or input into the radio frequency circuit 1004 for voice communication. For stereo acquisition or noise reduction, there are a plurality of microphones, which are respectively disposed at different parts of the terminal device 1000. The microphone is also an array microphone or an omnidirectional acquisition microphone. The loudspeaker is configured to convert the electrical signal from the processor 1001 or the radio frequency circuit 1004 into the sound waves. The loudspeaker is a conventional film loudspeaker or a piezoelectric ceramic loudspeaker. In the case that the loudspeaker is the piezoelectric ceramic speaker, the electrical signals can be converted into not only human-audible sound waves but also the sound waves which are inaudible to humans for ranging and the like. In some embodiments, the audio circuit 1007 further includes a headphone jack.

The power source 1008 is configured to supply power for various components in the terminal device 1000. The power source 1008 is an alternating current, a direct current, a disposable battery, or a rechargeable battery. In the case that the power source 1008 includes the rechargeable battery, the rechargeable battery is a wired charging battery or a wireless charging battery. The wired charging battery is a battery that is charged through a wired line, and a wireless charging battery is a battery that is charged through a wireless coil. The rechargeable battery also supports the fast-charging technology.

In some embodiments, the terminal device 1000 further includes one or more sensors 1009. The one or more sensors 1009 include, but are not limited to, an acceleration sensor 1011, a gyro sensor 1012, a force sensor 1013, an optical sensor 1014, and a proximity sensor 1015.

The acceleration sensor 1011 is configured to detect magnitudes of accelerations on three coordinate axes of a coordinate system established by the terminal device 1000. For example, the acceleration sensor 1011 is configured to detect components of gravitational acceleration on the three coordinate axes. The processor 1001 controls the display screen 1005 to display a user interface in a landscape view or a portrait view based on a gravity acceleration signal acquired by the acceleration sensor 1011. The acceleration sensor 1011 is also configured to acquire motion data of a game or a user.

The gyro sensor 1012 is configured to detect a body direction and a rotation angle of the terminal device 1000, and cooperates with the acceleration sensor 1011 to acquire a 3D motion of the user on the terminal device 1000. Based on the data acquired by the gyro sensor 1012, the processor 1001 achieves the following functions: motion sensing (for example, changing the UI according to a user's tilting operation), image stabilization during shooting, game control, and inertial navigation.

The force sensor 1013 is disposed at a side frame of the terminal device 1000 and/or a lower layer of the display screen 1005. In the case that the force sensor 1013 is disposed on the side frame of the terminal device 1000, a user's holding signal to the terminal device 1000 can be detected, and the processor 1001 can perform left-right hand recognition or quick operation according to the holding signal acquired by the force sensor 1013. In the case that the force sensor 1013 is disposed on the lower layer of the display screen 1005, the processor 1001 controls an operability control on the UI based on a user's press operation on the display screen 1005. The operability control includes at least one of a button control, a scroll bar control, an icon control, and a menu control.

The optical sensor 1014 is configured to acquire ambient light intensity. In some embodiments, the processor 1001 controls the display brightness of the display screen 1005 based on the ambient light intensity acquired by the optical sensor 1014. In some embodiments, in the case that the ambient light intensity is higher, the display brightness of the display screen 1005 is increased; and in the case that the ambient light intensity is lower, the display brightness of the display screen 1005 is decreased. In another embodiment, the processor 1001 also dynamically adjusts the shooting parameters of the camera assembly 1006 based on the ambient light intensity acquired by the optical sensor 1014.

The proximity sensor 1015, also referred to as a distance sensor, is usually disposed on the front panel of the terminal device 1000. The proximity sensor 1015 is configured to acquire a distance between the user and the front side of the terminal device 1000. In some embodiments, in the case that the proximity sensor 1015 detects that the distance between the user and the front side of the terminal device 1000 is gradually decreasing, the processor 1001 controls the display screen 1005 to switch from a screen-on state to a screen-off state; and in the case that the proximity sensor 1015 detects that the distance between the user and the front side of the terminal device 1000 is gradually increasing, the processor 1001 controls the display screen 1005 to switch from the screen-off state into the screen-on state.

It will be appreciated by those skilled in the art that the structure illustrated in FIG. 10 does not constitute limitation of the terminal device 1000, and may include more or fewer components than illustrated, or a combination of certain components, or a different component arrangement.

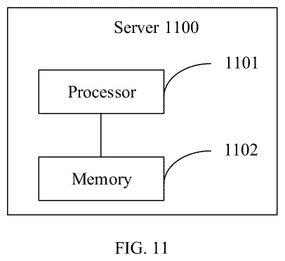

FIG. 11 is a schematic structural diagram of a server according to some embodiments of the present disclosure. The server 1100 varies greatly depending on configuration or performance, and includes one or more processors 1101 and one or more memories 1102. The one or more memories 1102 store at least one computer program. The at least one computer program, when loaded and executed by the one or more processors 1101, cause the one or more processors 1101 to perform the method for rendering the image according to the above method embodiments. Exemplarily, the processors 1101 are CPUs. In addition, the server 1100 further includes a wired or wireless network interface, a keyboard, an input/output interface, and other components to facilitate input and output. The server 1100 further includes other components for implementing functions of the device, which are not repeated herein.

In some embodiments, a computer-readable storage medium is further provided. The storage medium stores at least one computer program. The at least one computer program, when loaded and executed by a processor of an electronic device, causes the electronic device to perform the method for image rendering described above.

In some embodiments, the above-mentioned computer-readable storage medium includes a read-only memory (ROM), random access memory (RAM), compact disc read-only memory (CD-ROM), magnetic tape, soft disk, optical data storage device, and the like.

In some embodiments, a computer program or computer program product is further provided. The computer program or computer program product stores at least one computer program. The at least one computer program, when loaded and executed by a processor of an electronic device, causes the electronic device to perform the method for image rendering described above.

It should be understood that the term “a plurality of” means two or more. The term “and/or” describes the association relationship of the associated objects, and indicates that three relationships may be present. For example, A and/or B may indicate that only A is present, both A and B are present, and only B is present. The symbol “/” generally indicates an “or” relationship between the associated objects.

The serial numbers of the embodiments of the present disclosure are merely for description, and do not represent the advantages and disadvantages of the embodiments.

Described above are merely exemplary embodiments of the present disclosure and are not intended to limit the present disclosure. Any modifications, equivalents, improvements, and the like, made within the principle of the present disclosure should fall within the protection scope of the present disclosure.

What is claimed is:

1. A method for rendering an image, comprising:
acquiring a plurality of pieces of raw point cloud data by scanning an object with a scanning device, wherein any one piece of raw point cloud data is configured to describe a data acquisition point on the object;
determining at least one piece of boundary line data based on the plurality of pieces of raw point cloud data, wherein any one piece of boundary line data is configured to describe a contour boundary on the object; and
determining an object image based on the plurality of pieces of raw point cloud data and the at least one piece of boundary line data, and rendering the object image.

2. The method for rendering the image according to claim 1, wherein said determining at least one piece of boundary line data based on the plurality of pieces of raw point cloud data comprises:
acquiring a plurality of pieces of target point cloud data by filtering out raw point cloud data satisfying a filtering condition from the plurality of pieces of raw point cloud data; and
determining at least one piece of boundary line data based on the plurality of pieces of target point cloud data, and wherein
said determining the object image based on the plurality of pieces of raw point cloud data and the at least one piece of boundary line data comprises:
determining the object image based on the plurality of pieces of target point cloud data and the at least one piece of boundary line data.

3. The method for rendering the image according to claim 2, wherein the any one piece of raw point cloud data comprises coordinate data; and the raw point cloud data satisfying the filtering condition comprises raw point cloud data with coordinate data outside of a set area;
and/or, the any one piece of raw point cloud data comprises color data; and the raw point cloud data satisfying the filtering condition comprises raw point cloud data with color data matching a set color;
and/or, the any one piece of raw point cloud data comprises reflection intensity data; and the raw point cloud data satisfying the filtering condition comprises raw point cloud data with reflection intensity data less than a set reflection intensity.

4. The method for rendering the image according to claim 2, wherein said determining at least one piece of boundary line data based on the plurality of pieces of target point cloud data comprises:
acquiring at least two first point cloud clusters by partitioning the plurality of pieces of target point cloud data, wherein any first point cloud cluster comprises at least one piece of target point cloud data;
determining, for any two first point cloud clusters, boundary line data between the any two first point cloud clusters based on each piece of target point cloud data in the any two first point cloud clusters; and
determining, in a case that the at least two first point cloud clusters satisfy a partitioning condition, boundary line data between every two first point cloud clusters as at least one piece of boundary line data.

5. The method for rendering the image according to claim 4, wherein said acquiring at least two first point cloud clusters by partitioning the plurality of pieces of target point cloud data comprises:
determining, for any two pieces of target point cloud data, a distance between the any two pieces of target point cloud data based on coordinate data in the any two pieces of target point cloud data; and
partitioning, in a case that a difference between color data in the any two pieces of target point cloud data is less than a first threshold and a distance between the any two pieces of target point cloud data is less than a second threshold, the any two pieces of target point cloud data into a same first point cloud cluster.

6. The method for rendering the image according to claim 4, wherein said determining the boundary line data between the any two first point cloud clusters based on each piece of target point cloud data in the any two first point cloud clusters comprises:
determining a plurality of pieces of reference point cloud data from the each piece of target point cloud data in the any two first point cloud clusters, wherein a distance between each piece of the reference point cloud data and one of the any two first point cloud clusters is less than a third threshold, and a distance between each piece of the reference point cloud data and the other of the any two first point cloud clusters is less than a fourth threshold;
determining, for any two pieces of reference point cloud data, straight-line data based on the any two pieces of reference point cloud data;
determining distances between other point cloud data and the straight-line data, wherein the other point cloud data are target point cloud data from the each piece of target point cloud data in the any two first point cloud clusters except the any two pieces of reference point cloud data; and
determining, in a case that a quantity of other point cloud data with distances to the straight-line data less than a fifth threshold satisfies a quantity condition, the straight-line data as the boundary line data between the any two first point cloud clusters.

7. The method for rendering the image according to claim 4, further comprising:
acquiring at least two second point cloud clusters by partitioning, for any first point cloud cluster, in a case that the at least two first point cloud clusters do not satisfy the partitioning condition, each piece of target point cloud data in the any first point cloud cluster, wherein any second point cloud cluster comprises at least one piece of target point cloud data;
determining, for any two second point cloud clusters, boundary line data between the any two second point cloud clusters based on each piece of target point cloud data in the any two second point cloud clusters; and
determining, in a case that each second point cloud cluster satisfies the partitioning condition, boundary line data between every two first point cloud clusters and boundary line data between every two second point cloud clusters as at least one piece of boundary line data.

8. The method for rendering the image according to claim 1, wherein said rendering the object image comprises:
acquiring an offset between a reference point of a display screen on a head-mounted display device and a reference point of the object image;
acquiring an offset object image by offsetting the object image based on the offset; and
rendering the offset object image on the display screen.

9. An apparatus for rendering an image, comprising:
a scanning module, configured to acquire a plurality of pieces of raw point cloud data by scanning an object with a scanning device, wherein any one piece of raw point cloud data is configured to describe a data acquisition point on the object;
a determining module, configured to determine at least one piece of boundary line data based on the plurality of pieces of raw point cloud data, wherein any one piece of boundary line data is configured to describe a contour boundary on the object, wherein
the determining module is further configured to determine an object image based on the plurality of pieces of raw point cloud data and the at least one piece of boundary line data; and
a rendering module, configured to render the object image.

10. An electronic device comprising a processor and a memory storing at least one computer program, wherein the at least one computer program, when loaded and executed by the processor, causes the electronic device to perform the method for rendering the image as defined in any one of claims 1 to 8.
